(19) United States
(12) Patent Application Publication
(10) Pub. No.: US 2025/0319556 A1
(43) Pub. Date: Oct. 16, 2025

(54) TOOL DISPOSING BRACKET

(71) Applicant: Lukasz Tomczyk, Paris (CA)

(72) Inventor: Lukasz Tomczyk, Paris (CA)

(21) Appl. No.: 19/173,351

(22) Filed: Apr. 8, 2025

Related U.S. Application Data
(60) Provisional application No. 63/632,693, filed on Apr. 11, 2024.

(51) Int. Cl. B23Q 3/02

(52) U.S. Cl. CPC B23Q 3/02

(57) ABSTRACT

Provided is a tool system and bracket to dispose a tool of the tool system in an upright orientation and a method of manufacturing the same. The tool is configured to be set down in a resting disposition and picked up at a handle. The bracket is for disposing the tool, in the resting position, in the upright orientation. The bracket includes a baseplate with a horizontal leg connected to a vertical leg. In the resting disposition, the horizontal leg is configured to lie against a resting surface at a resting interface. The bracket includes a guide shaft configured to be attached to a body of the tool via attachment points at a far end of the tool, the far end is located opposite the handle along a longitudinal axis of the tool. A connecting shaft connects the baseplate and the guide shaft.

### TECHNICAL FIELD

The following relates generally to brackets for effecting a disposition of tools between uses, and more particularly to brackets for effecting the disposition of hand tools between uses of a session.

### INTRODUCTION

There is often a need to set hand tools such as circular saws down during a given use session. For example, a tool may need to be used set down intermittently to use other tools or a user may need to set the tool down to rest during prolonged use.

With existing tools, the unassisted available resting dispositions (position and orientation) of the tool once set down may not be ideal. For example, the tool may be oriented or positioned in a manner that retrieving the tool for future use is difficult or harmful to the user (i.e. due to or causing pain). Furthermore, these unassisted resting positions are often hazardous to the surrounding environment due, for example, to sharp and/or hard aspects of the hand tool. The position may also risk damage to the tool, for example due to environment factors such as water or snow or by impacting or putting pressure on sharpened or particularly aligned components of the tool.

In some existing systems a stand is secured to a structure and is configured to receive the hand tool in an advantageous disposition. While the securing may mitigate tipping risk, it limits the location where the hand tool may be placed to a single location. While the securing of some existing stands may be releasable, releasing and securing the stand to change the location the hand tool still requires significant effort and limits the potential locations to those that accommodates the particular securing mechanism particularly if the securing mechanism is destructive.

In some existing systems, a stand is placed on a surface and is configured to receive the hand tool. However, as the action of inserting the hand tool into the stand is subject to tipping risks, these stands include bulky features that add weight and/or volume to stand which are problematic in the field or during storage. Additionally, similar to the secured stands, these stands need to be moved independently to set the hand tool down in a new location. This can be difficult, harmful, or risky when the user's hands are also occupied with the tool.

In some existing systems, custom stands are provided to accommodate a feature of specific hand tool or line of hand tools in a specific configuration. These brackets necessarily rely on the presence of this feature in the predetermined configuration and therefore only accommodate specific hand tools. If the tool is to be replaced this either limits the replacement options or renders the stand obsolete. Furthermore, in existing systems, using these stands necessarily includes the removal of parts to the tool essential to the operation of the tool. Therefore, while these stands may accommodate tool storage, they removal and replacement of these parts is inefficient for use in the field.

Accordingly, there is a need for an improved tool disposing bracket that overcomes at least some of the disadvantages of existing tool disposing mechanisms.

### SUMMARY

Provided is a tool system configured to dispose a tool of the tool system in an upright orientation. The tool system includes the tool configured to be set down on a resting surface in a resting disposition and to be picked up by the hand of a user for use. The tool includes a body for forming the structure of the tool. The body includes a handle configured to receive the hand for picking up the tool. The tool system includes a bracket for disposing the tool, when set down in the resting position, in the upright orientation. The bracket includes a baseplate configured to form a base of the bracket. The baseplate includes a horizontal leg connected to a vertical leg for forming the structure of the baseplate. Where the tool is disposed in the resting disposition, the horizontal leg is configured to lie against the resting surface at a resting interface and the vertical leg forms a at least partially vertical structure of the baseplate. The bracket includes a guide shaft configured to be attached to the body. The attachment is at a far end of the tool via one or more attachment points. The far end is located opposite the handle along a longitudinal axis of the tool. The bracket includes a connecting shaft connected to the baseplate and the guide shaft.

The guide shaft may be configured such that the attachment to the body is releasable for enabling removal of the bracket.

At least one of the one or more attachment points may include a set screw for securing the attachment.

At least one of the one or more attachment points may include a guide hole and the guide shaft may be configured to be received by the guide hole according to standard guide hole dimensions.

The baseplate and guide shaft may be disposed along the connecting shaft such that, when the bracket is attached to the tool, the baseplate is disposed clear of operational components of the tool.

The horizontal leg may be configured in a towed out configuration such that, when the bracket is attached to the tool, the baseplate is disposed clear of operational components of the tool.

The horizontal leg may include cutouts.

In another aspect, provided is a bracket for attaching to a tool and disposing the tool, when set down in the resting position, in an upright orientation. The bracket includes a baseplate configured to forming a base of the bracket. The baseplate includes a horizontal leg connected to a vertical leg for forming the structure of the baseplate. Where the tool is disposed in the resting disposition, the horizontal leg is configured to lie against the resting surface at a resting interface and the vertical leg forms a at least partially vertical structure of the baseplate. The bracket includes a guide shaft configured to be attached to a body of the tool. The attachment is at a far end of the hand tool via one or more attachment points. The far end is located opposite a handle of the tool along a longitudinal axis of the tool. The bracket includes a connecting shaft connected to the baseplate and the guide shaft.

The guide shaft may be configured such that the attachment to the body is releasable for enabling removal of the bracket.

The guide shaft may be configured to be received by a guide hole of at least one of the one or more attachment points according to standard guide hole dimensions.

The baseplate and guide shaft may be disposed along the connecting shaft such that, when the bracket is attached to the tool, the baseplate is disposed clear of operational components of the tool.

The horizontal leg may be configured in a towed out configuration such that, when the bracket is attached to the tool, the baseplate is disposed clear of operational components of the tool.

The horizontal leg may include cutouts.

In another aspect, provided is a method of manufacturing a tool system for disposing a tool of the tool system in an upright position when the tool is set down in the resting position on a resting surface. The method includes connecting a base plate to a connecting shaft wherein the baseplate is configured to form a base of a bracket. The baseplate includes a horizontal leg connected to a vertical leg for forming the structure of the baseplate. Where the tool is disposed in the resting disposition, the horizontal leg is configured to lie against the resting surface at a resting interface and the vertical leg forms at least partially vertical structure of the baseplate. The method includes connecting a guide shaft to the connecting shaft. The guide shaft is configured to be attached to a body of the tool via one or more attachment points located at a far end of the tool. The far end is located opposite a handle of the tool along a longitudinal axis of the tool.

Connecting the guide shaft to the connecting shaft may be at a location along the connecting shaft such that, when the bracket is attached to the tool, the baseplate is disposed clear of operational components of the tool.

The method may include attaching the guide shaft to the body of the tool via the one or more attachment points.

The attachment may be releasable for enabling removal of the bracket.

Attaching the guide shaft may include tightening a set screw to secure the attachment.

At least one of the one or more attachment points may include a guide hole and attaching the guide shaft may include inserting the guide shaft through the guide hole.

The method may include cutting the horizontal leg to obtain cutouts in the horizontal leg and bending the baseplate to configure the baseplate in a towed out configuration.

Other aspects and features will become apparent to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a block diagram of a tool system including a disposing bracket, according to an embodiment.

FIGS. 2A through 2D, are photographs of the tool system of FIG. 1 from various views, according to an embodiment;

FIG. 2E is a photograph of the tool system of FIGS. 2A through 2D with the bracket of partially attached, according to an embodiment;

FIGS. 3A through 3B, are photographs of the tool system of FIG. 1 from various views, according to a further embodiment;

FIG. 4 is a block diagram of the bracket of FIG. 1, according to an embodiment;

FIGS. 5A through 5E are a schematic diagram of the bracket of FIG. 4 from a perspective, front, back, left, right, top, and bottom view, respectively, according to an embodiment;

FIGS. 6A through 6C are photographic images from various views of the bracket of FIGS. 5A through 5E, according to an embodiment;

FIGS. 7A through 7E are a schematic diagram of the bracket of FIG. 4 from a perspective, front, back, left, right, top, and bottom view, respectively, according to an embodiment;

FIGS. 8A through 8E are photographic images from various views of the bracket of FIGS. 7A through 7E, according to an embodiment; and

FIGS. 9A through 9E are photographic images from various views of the bracket of FIG. 4, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following relates generally to brackets for effecting a disposition of tools between uses, and more particularly to brackets for effecting the disposition of hand tools between uses of a session. The bracket of the present disclosure is configured to connect to a hand tool such as circular saw. When connected, the bracket enables the tool to be put down and rest in an upright position such that a handle of the tool is conveniently and beneficially disposed for lifting the tool. This disposition of the handle mitigates bending required by a user to lift the tool facilitating lifting of the tool by users and beneficially mitigating or avoiding potential pain, suffering or injury.

Furthermore, when connected, the bracket enables the tool to be down such that it is elevated from the resting surface. This elevation further contributes to the bending mitigation described above. The elevation also beneficially mitigates potential damage risks to the surface and critical tool elements including damage to tool or the surface from direct contact of from resting surface environment concerns such as water, snow, chemicals, and salt.

The bracket is further configured such that it can remain connected to the tool during use and accommodates operation of the tool while connected. Maintaining the connection of the bracket and the tool during the operation enables placement of the tool in different locations after every use without the need to independently move the bracket. Maintaining the connection also beneficially expands potential resting surfaces and reduces installation frequency over existing systems/stands as the bracket is secured to the tool rather than an external surface. This maintained connection also beneficially extends the life of the tool as the bracket may be securely disposed to impart the resting forces and impulses attributable to putting down the tool to components of the tool that accommodate such forces and impulses (including by deforming in non-critical manners) Furthermore, the connection mitigates risks and attention required inherent in placing the tool in a stand such as tipping or misplacement particularly where the bracket is an intuitive extension of the hand tool.

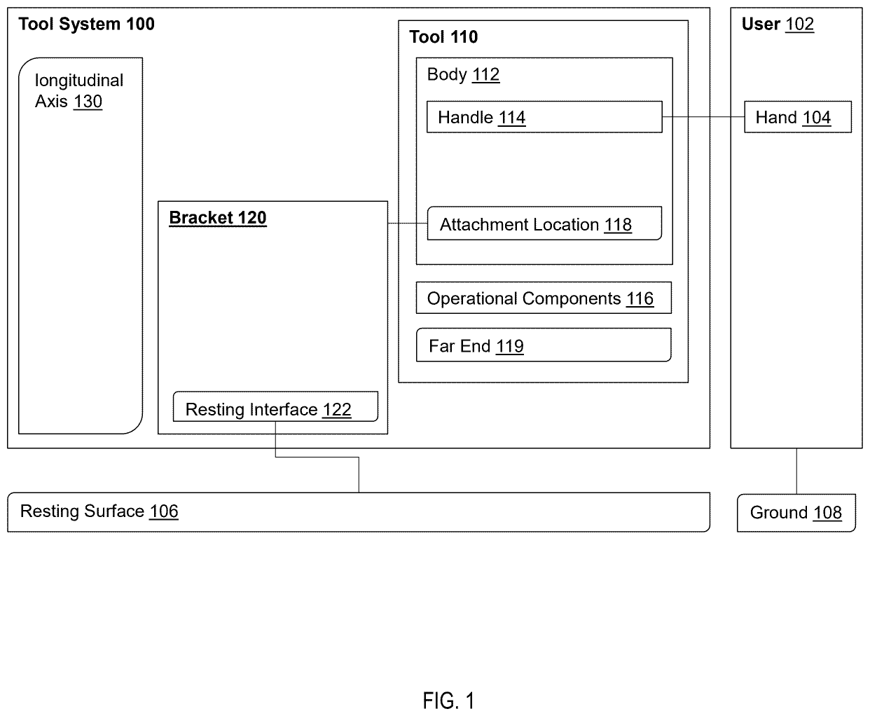

Referring now to FIG. 1, shown therein is a block diagram of a tool system 100 including a disposing bracket 120, according to an embodiment.

The tool system 100 includes a hand tool 110 or tool 110. The tool 110 is a tool intended to be picked up or retrieved and used by a user 102. For example, the tool 110 may be a circular saw.

The hand tool 110 includes a body 112 for forming the structure of the tool 110.

The body 112 includes a handle 114 configured to be grasped by one or more hands 104 of the user 102, for example when the tool 110 is being picked up. The user 102 will pick up or retrieve the tool 110 by grasping the handle 114 and removing the tool 110 from a resting surface 106 such as the ground 108, work bench or work table. The picking up may be for example for using or relocating the tool 110.

It will be appreciated that the user 102 may or may not be standing on the resting surface 106. For example, the user 102 may be standing on the ground 108 or another surface such the step of a ladder. The user 102 may be standing in a manner or location where a tool resting flat on the resting surface 106 is out of reach or sub-optimally within reach of the hands 104 of the user 102. For example, the user 102 may be standing upright or on an elevated surface. Retrieving tools from these positions may necessitate the user 102 to inefficiently relocate (i.e. come down from a ladder) or bend over and be exposed to potential pain, suffering or injury. Therefore, it is beneficial to minimize these out of reach and sub-optimal reach situations by having the handle 114 of the tool 110 disposed in a reachable position and optimal orientation.

The tool 110 further includes at least one set of operational components 116. The set of operational components 116 includes the component or set of components of the tool 110 that necessarily contributes to the use of the tool 110 for at least one purpose. A tool 110 with multiple purposes involving distinct or overlapping sets of components is expressly contemplated. It will be appreciated that the operational component sets 116 referred to herein only refer to operational component sets 116 that are enabled by the tool system 100.

For reference, an end of the tool 110 distant from the handle 114 is referred to herein as a far end 119. In some embodiments, the far end 119 is defined by a point on the tool 110 farthest from the handle 114. In some embodiments, the far end 119 is defined by a point on the tool 110 farthest from the handle 114 on a line intersecting the center of mass of the tool 119 and the handle 114. In some embodiments, the far end 26 is point selected based on available bracket attachment points 118, further described below. In some embodiments, the far end 119 is selected by optimizing combinations of the above described embodiments.

The tool system 100 further includes the disposing bracket 120. The backet 120 is configured to physically attach to the body 112 of the tool 110.

Each location where the bracket 120 attaches to the body 112 is referred to herein as the attachment location 118. It will be appreciated that the attachment location 118 may be a surface, line, point or combinations or multiples thereof.

In some embodiments, the attachment location 118 is located at or near the far end 119. Attachment locations 118 near the far end 119 minimize the extension of the bracket 120 required to clear the bracket of the far end 119 while maximizing the distance the bracket 120 is disposed from the handle 114.

It will be appreciated that a tool 110 may have any number of acceptable attachment locations 118. In some embodiments, the attachment location 118 is selected to utilize existing features of the body 112. In an example, the bracket is attached to the tool 110 through guide holes of the tool 110 which serve as the attachment location 118.

In some embodiments, the attachment location 118 is selected to accommodate the attachment method. In an example, the bracket 120 is attached to the tool 110 using existing manufacturing techniques such as welding or screws. In these embodiments locations of body 112 comprising metal or that are tappable, respectively are selected as attachment locations 118.

The attachment is such that the attachment is securely maintained while the tool 110 is picked up and used. In some embodiments the attachment is secured by releasable means. In an example, the attachment location 118 are guide holes of the tool 110 and the bracket 120 is secured in the guide holes by thumb screws. In some embodiments, the attachment is permanent. In an example, the bracket is formed as an integrated piece of the body such as via injection molding. Maintaining the attachment during use beneficially enables setting down the tool system 100 on different locations or resting surfaces 106 after each use without moving additional objects such as a stand. Maintaining the attachment also beneficially avoids the effort and damage risk inherent in existing systems, such as stands, that necessarily require the tool be set in a specific receiving location.

The attachment and configuration of the bracket 120 is such that the bracket 120 does not interfere with the handle 114 or at least one operational component set 116 of the tool 110. It will be appreciated that while the absence of interference from the bracket 120 may not be absolute, the bracket does not substantially interfere with the objects the tool 110 is operating on or environment the tool 110 is being operated in during use of the tool 110 for at least one purpose of the operational component set 116.

The bracket 120 extends from the attachment point to a resting interface 122. The resting interface 122 is disposed beyond the far end 119 of the tool 110.

The resting interface 122 is a surface of the bracket 120 configured to interface with the resting surface 106 when the tool system 100 is set down. In some embodiments, the resting interface 122 is substantially planar. This configuration enables the resting interface 122 to be flush with any resting surface 106 that is substantially planer when the tool 110 is set down.

As referred to herein, a longitudinal axis 130 of the tool system 100 extends from the handle 114 to the resting interface 112. The resting interface 122 is configured such that the resting interface 122 is substantially normal to longitudinal axis 130. This configuration beneficially facilitates placement of the tool system 100 on the resting surface 106 such that the longitudinal axis 130 is normal to the resting surface 106. This orientation maximizes the disposition of the handle 114 of the tool 110 above the resting surface 106. This elevated disposition facilitates picking up the tool 110 without relocation or bending over.

In some embodiments, this orientation of the longitudinal axis 130 also disposes the handle 114 in an upright orientation. This orientation of the handle 114 optimally facilitates lifting of the tool 110 without inducing injury or pain.

It will be appreciated that the orientation of the longitudinal axis 130 may deviate from normal while still providing the benefits associated with an elevated handle disposition. For example, bracket 120 may be configured or attached to the tool 110 such that the longitudinal axis 130 deviates from normal to accommodate attachment locations 118 or stabilize and disperse the weight of the tool 110 evenly against the resting surface 106. This deviation may be up to the extent that the tool system 100 when placed on a planar resting surface 106 is substantially stable in an upright orientation.

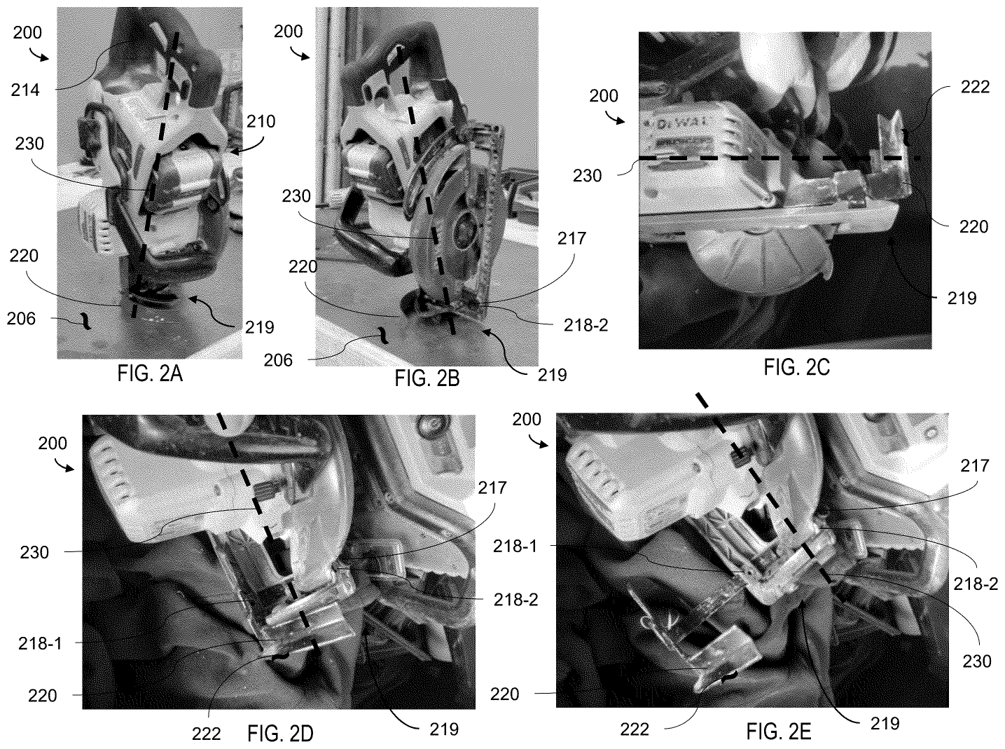

Referring to FIGS. 2A through 2D, shown therein are photographs of a tool system 200 from various views, according to an embodiment. Referring also to FIG. 2E shown therein it the tool system 200 with the bracket 220 partially attached, according to an embodiment. It will be appreciated that t The tool system 200 is an embodiment of the tool system 100 of FIG. 1.

The tool system 200 includes a hand tool 210. The hand tool 210 is a battery hand operated circular saw.

The hand tool incudes a handle 214 for lifting the hand tool 210 from a resting surface 206.

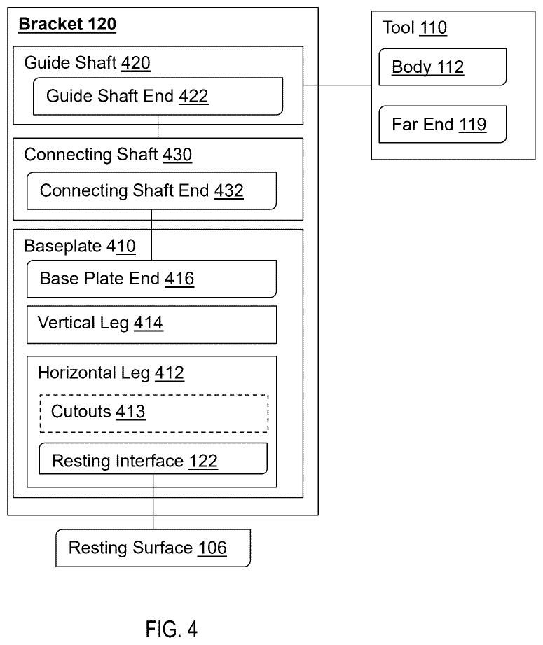

The hand tool 210 includes attachment locations 218-1 and 218-2. The attachment locations 218-1 and 218-2 are configured as guide slots 218-1 and 218-2 for receiving and releasable securing a guide shaft such as the guide shaft 422 of FIG. 4 described below. It will be appreciated that guide slots such as the guide slots 218-1 and 218-2 are typical features of hand tools such as battery powered circular saws. The guide slots 218-1 and 218-2 are disposed at a far end 219 opposite the handle 214.

The tool system 200 includes a bracket 220. The bracket 220 is configured to releasably attach to the hand tool 210 at the attachment locations 218-1 and 218-2. The attachment disposes the bracket at the far end 219. A resting interface 222 of the bracket 220 is disposed such that, when the bracket is attached to the hand tool 210, the resting interface 222 is facing substantially opposite the handle. When the tool system is put down, the resting interface 222 interfaces with the resting surface 206. In this disposition, the disposition of the resting interface 222 in the tool system 200 orients a longitudinal axis 230 of the hand tool system 200 defined at a first end by the handle 214 and at a second end by the far end 219, substantially vertical (i.e. perpendicular to the resting surface 206). It will be appreciated that the longitudinal axis 230 may deviate from vertical as long as the tool system 200 is stable on the resting surface 206.

The bracket 220 is removeable. To configure the tool system 200 in an attached configuration, the bracket 220 may be inserted into the guide slot 218-1 (as shown in FIG. 2E) and slid through to the guide slot 218-2 (as shown in FIG. 2D). The attachment may be secured, such as by a set screw 217 at the guide slots 218-1 or 218-2. The set screw 217 may be a thumb screw for toolless securing.

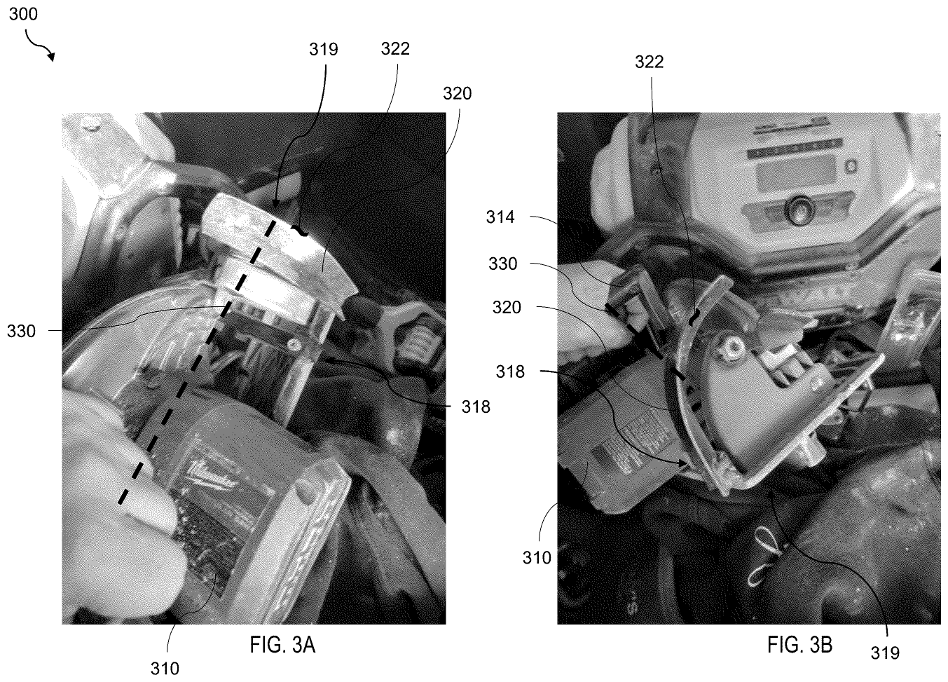

Referring to FIGS. 3A and 3B, shown therein is tool system 300, according to an embodiment. The tool system 300 is a further embodiment of the tool system 100 of FIG. 1.

The tool system 300 includes a hand tool 310. The hand tool 310 is a powered hand operated circular saw.

The hand tool incudes a handle 314 for lifting the hand tool 310.

The hand tool 310 includes attachment location 318. The attachment locations 318 is configured as a guide slot 318 for receiving and releasable securing a guide shaft such as the guide shaft 422 of FIG. 4 described below. It will be appreciated that guide slots, such as the guide slot 318, are typical features of hand tools such as powered hand operated circular saws. The guide slot 318 is disposed at a far end 319 opposite the handle 314.

The tool system 300 includes a bracket 320. The bracket 320 is configured to releasably attach to the hand tool 310 at the attachment location 318. The attachment disposes the bracket at the far end 319. A resting interface 322 of the bracket 320 is disposed such that, when the bracket is attached to the hand tool 310, the resting interface 322 is facing substantially opposite the handle. When the tool system is put down, the disposition of the resting interface 322 in the tool system 300 orients a longitudinal axis 330 of the hand tool system 300 defined at a first end by the handle 314 and at a second end by the far end 319, substantially vertical.

The bracket 320 is removeable. The attachment may be secured, such as by a set screw 317 at the guide slot 318.

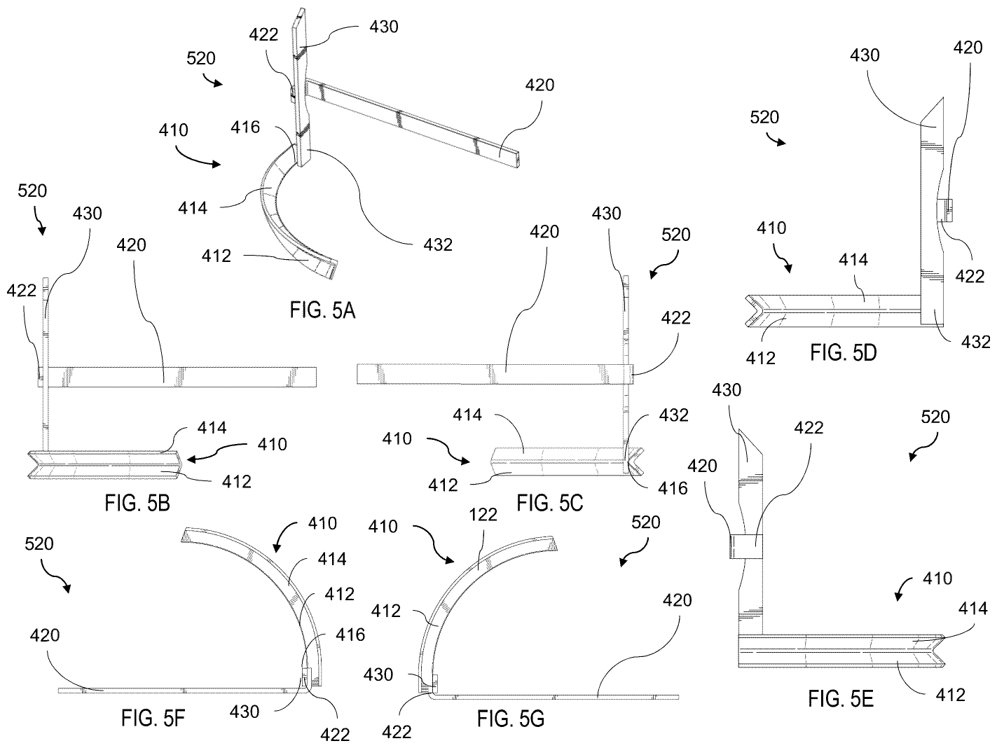

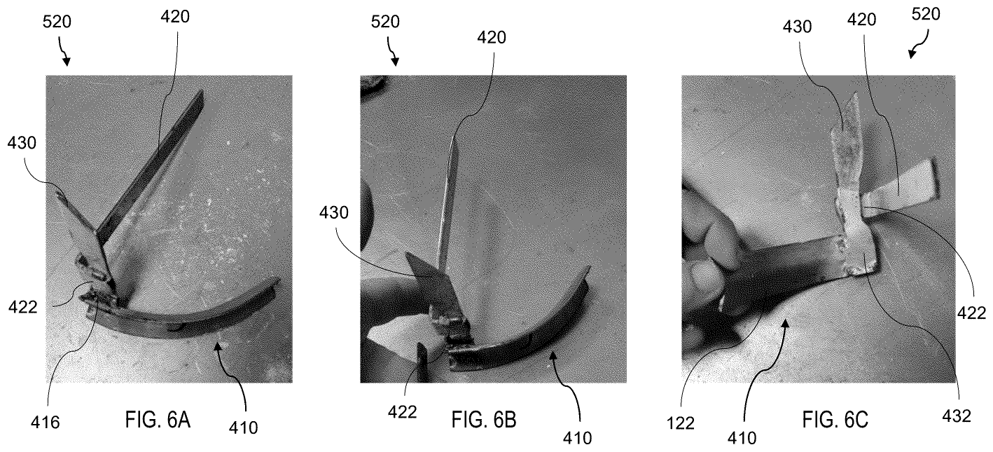

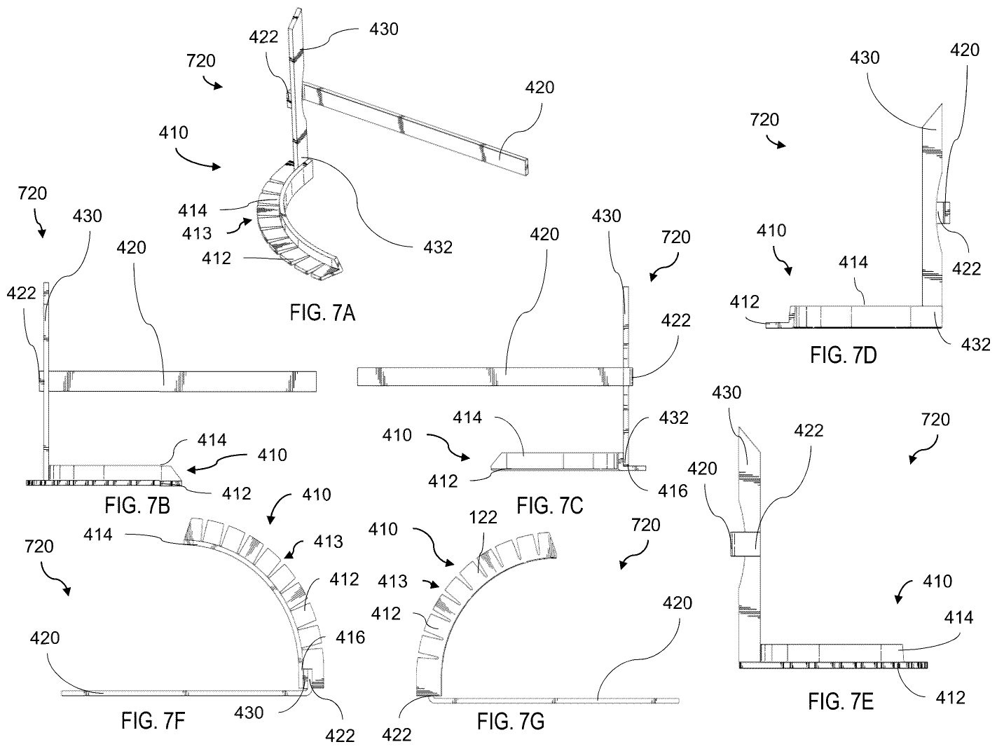

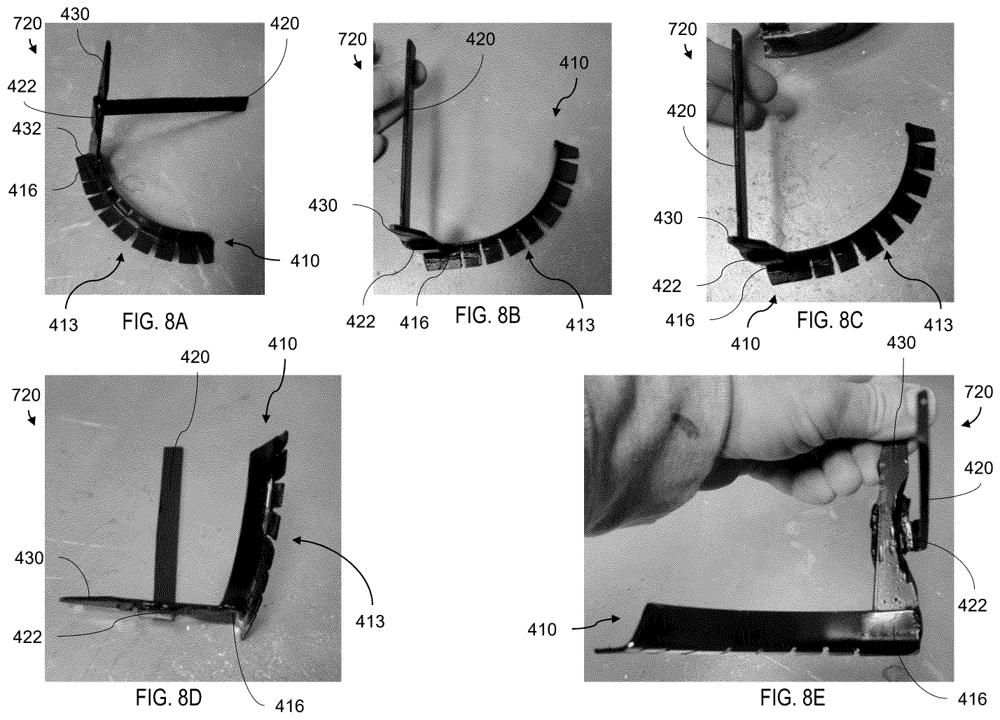

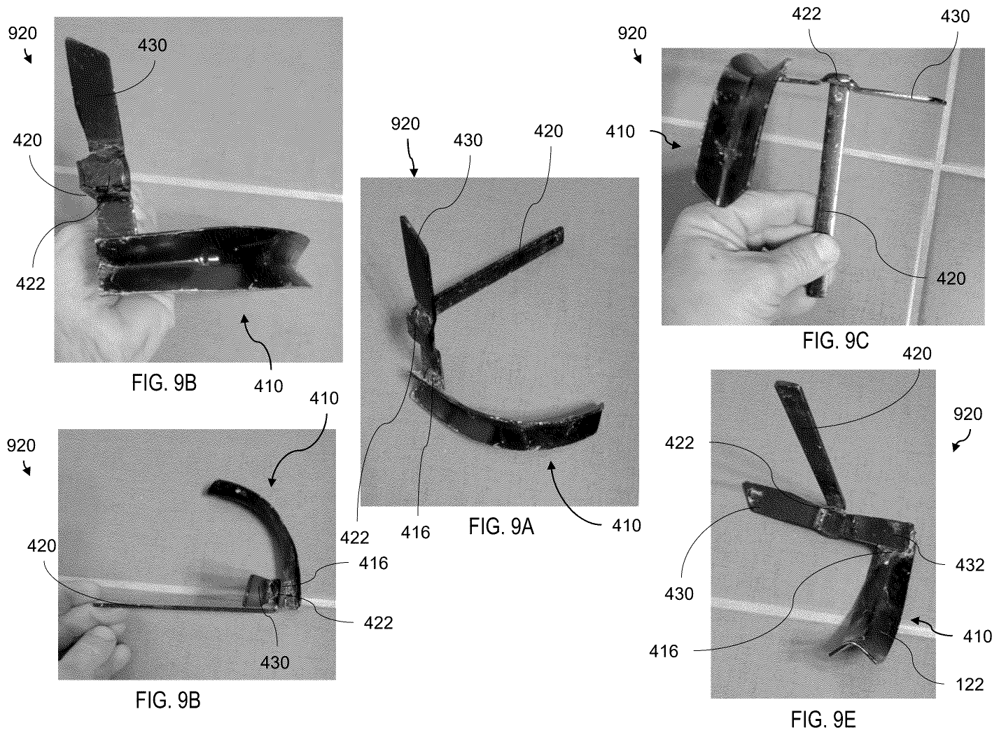

Referring to FIG. 4, shown therein is block diagram of a bracket 120, according to an embodiment. Referring also to FIGS. 5A through 5E, shown therein is a perspective, front, back, left, right, top and bottom view, respectively, schematic diagram of a bracket 520, according to an embodiment. The bracket 520 is an embodiment of the bracket 120 of FIG. 4 and is similarly configured. Referring also to FIGS. 6A through 6C, shown therein are photographic images from various views of a bracket 520, according to an embodiment. Referring also to FIGS. 7A through 7E, shown therein is a perspective, front, back, left, right, top and bottom view, respectively, schematic diagram of a bracket 720, according to an embodiment. The bracket 720 is a further embodiment of the bracket 120 of FIG. 4 and is similarly configured. Referring also to FIGS. 8A through 8E shown therein are photographic images from various views a bracket 720, according to an embodiment. Referring also to FIGS. 9A through 9E shown therein are photographic images from various views a bracket 920, according to an embodiment. The bracket 920 is a further embodiment of the bracket 120 of FIG. 4 and is similarly configured.

The bracket 120 includes a baseplate 410. The baseplate 410 forms a base of the bracket 120. The baseplate 410 is composed of any material sufficiently rigid to support and stabilize the tool 110. In some embodiments, the baseplate 410 is metal. The baseplate 410 is disposed on the bracket 120 such that, when attached to the tool 110 the baseplate 410 clears the far end 119 of tool 110. Where the bracket 120 is attached to the tool 110, the baseplate 410 facilitates placing the tool 110 on the resting surface 106 such that the tool 110 sits in an upright orientation, firmly and evenly against the resting surface 106.

The baseplate 410 includes a horizontal leg 412. The horizontal leg 412 provides the structure of the bracket 120 that interfaces with the resting surface 106. Where the bracket 120 is attached to the tool 110, the surface of the horizontal leg 412 facing away from the tool 110 is the resting interface 122.

In some embodiments, the horizontal leg 412 includes one or more cutouts 413. The cutouts 413 are voids in the horizontal leg 412. The cutouts 413 may be formed in the horizontal leg 413 by cutting material from the horizontal leg 412. The cutouts 413 enable bending the baseplate into a circular profile further described below.

The baseplate 410 further includes a vertical leg 414. The vertical leg 414 is disposed substantially perpendicular to the horizontal leg 412 to form the substantially L shaped form of the baseplate 410. It will be appreciated that the baseplate 410 may be formed from a single piece, bent or otherwise formed into an L shape (i.e. an L channel). As such the connection between the horizontal leg 412 and vertical leg 414 may be rounded.

The baseplate 410 is shaped in a circular profile, also known as a toe out. In some embodiments, the circular profile is tapered at one end. In some embodiments, the circular profile from a quarter of a circle. In some embodiments, the baseplate 410 is between five and seven inches. This configuration beneficially facilitates the distribution of tool 110 weight while avoiding interference with the operational components of the tool 110, such as the operation component set 116 of FIG. 1.

The bracket 120 includes a guide shaft 420. The guide shaft 420 provides a structure for attaching the bracket 120 to the tool 110. The guide shaft 420 is composed of any material sufficiently rigid to support the tool 110. The guide shaft 420 is not necessarily composed of the same material as the other parts of the bracket 120.

The guide shaft 420 is configured based on the intended method of attaching to the tool 110. In an example, the guide shaft 420 is intended to attach to the tool by being slid into half-inch guide holes of the tool 110. In this example, the guide shaft 420 is a half-inch thick, seven to nine inch log flat bar.

The bracket 120 includes a connecting shaft 430. The connecting shaft 430 is configured to connect the baseplate 410 to the guide shaft 420. The connecting shaft 430 is further configured to support the tool 110 in the upright orientation. The connecting shaft 430 is composed of any material sufficiently rigid to support the tool 110. The connecting shaft 430 is not necessarily composed of the same material as the other parts of the bracket 120.

The connecting shaft 430 is connected at a connecting shaft end 432 to a base plate end 416 of the base plate 410. The guide shaft 420 is connected at a guide shaft end 422 to the connecting shaft 430. The guide shaft 420 is connected to the connecting shaft 430 at any point along the length of the connecting shaft 430 such that the baseplate 410 is sufficiently distanced from the guide shaft 420 to clear the far end 119 of the tool 110. In an example the connecting shaft 430 is a four to five inch long flat bar tapered on one end.

The guide shaft Is configured such that when the bracket is attached to the tool 110, the connecting shaft 430 hugs the body 112 of the tool 110. In some embodiments, the guide shaft 420 includes a notch at the connecting shaft end 432 to accommodate the body of the tool 110.

The connections of the guide shaft 420 and the baseplate 410 to the connecting shaft 430 may be by any existing manufacturing means. In an example, the guide shaft 420 is bent ninety degrees at the guide shaft end 422 and welded to the connecting shaft 430.

While the above description provides examples of one or more apparatus, methods, or systems, it will be appreciated that other apparatus, methods, or systems may be within the scope of the claims as interpreted by one of skill in the art.

1. A tool system configured to dispose a tool of the tool system in an upright orientation, the tool system comprising:
the tool configured to be set down on a resting surface in a resting disposition and to be picked up by the hand of a user for use, the tool comprising a body for forming the structure of the tool the body comprising a handle configured to receive the hand for picking up the tool; and
a bracket for disposing the tool, when set down in the resting position, in the upright orientation, the bracket comprising:
a baseplate configured to form a base of the bracket, the baseplate comprising a horizontal leg connected to a vertical leg for forming the structure of the baseplate, wherein, where the tool is disposed in the resting disposition, the horizontal leg is configured to lie against the resting surface at a resting interface and the vertical leg forms a at least partially vertical structure of the baseplate,
a guide shaft configured to be attached to the body wherein the attachment is at a far end of the tool via one or more attachment points, the far end located opposite the handle along a longitudinal axis of the tool; and
a connecting shaft connected to the baseplate and the guide shaft.

2. The system of claim 1, wherein the guide shaft is configured such that the attachment to the body is releasable for enabling removal of the bracket.

3. The system of claim 2, wherein at least one of the one or more attachment points comprises a set screw for securing the attachment.

4. The system of claim 1, wherein at least one of the one or more attachment points comprises a guide hole and wherein the guide shaft is configured to be received by the guide hole according to standard guide hole dimensions.

5. The system of claim 1, wherein the baseplate and guide shaft disposed along the connecting shaft such that, when the bracket is attached to the tool, the baseplate is disposed clear of operational components of the tool.

6. The system of claim 1, wherein the horizontal leg is configured in a towed out configuration such that, when the bracket is attached to the tool, the baseplate is disposed clear of operational components of the tool.

7. The system of claim 6, wherein the horizontal leg comprises cutouts.

8. A bracket for attaching to a tool and disposing the tool, when set down in the resting position, in an upright orientation, the bracket comprising:
a baseplate configured to forming a base of the bracket, the baseplate comprising a horizontal leg connected to a vertical leg for forming the structure of the baseplate, wherein, where the tool is disposed in the resting disposition, the horizontal leg is configured to lie against the resting surface at a resting interface and the vertical leg forms a at least partially vertical structure of the baseplate,
a guide shaft configured to be attached to a body of the tool wherein the attachment is at a far end of the hand tool via one or more attachment points, the far end located opposite a handle of the tool along a longitudinal axis of the tool; and
a connecting shaft connected to the baseplate and the guide shaft.

9. The bracket of claim 8, wherein the guide shaft is configured such that the attachment to the body is releasable for enabling removal of the bracket.

10. The bracket of claim 8, wherein the guide shaft is configured to be received by a guide hole of at least one of the one or more attachment points according to standard guide hole dimensions.

11. The bracket of claim 8, wherein the baseplate and guide shaft disposed along the connecting shaft such that, when the bracket is attached to the tool, the baseplate is disposed clear of operational components of the tool.

12. The bracket of claim 8, wherein the horizontal leg is configured in a towed out configuration such that, when the bracket is attached to the tool, the baseplate is disposed clear of operational components of the tool.

13. The bracket of claim 12, wherein the horizontal leg comprises cutouts.

14. A method of manufacturing a tool system for disposing a tool of the tool system in an upright position when the tool is set down in the resting position on a resting surface, the method comprising:
connecting a base plate to a connecting shaft wherein the baseplate is configured to form a base of a bracket, the baseplate comprising a horizontal leg connected to a vertical leg for forming the structure of the baseplate, wherein, where the tool is disposed in the resting disposition, the horizontal leg is configured to lie against the resting surface at a resting interface and the vertical leg forms at least partially vertical structure of the baseplate;
connecting a guide shaft to the connecting shaft, wherein the guide shaft is configured to be attached to a body of the tool via one or more attachment points located at a far end of the tool, the far end located opposite a handle of the tool along a longitudinal axis of the tool.

15. The method of claim 14, wherein connecting the guide shaft to the connecting shaft is at a location along the connecting shaft such that, when the bracket is attached to the tool, the baseplate is disposed clear of operational components of the tool.

16. The method of claim 14 further comprising attaching the guide shaft to the body of the tool via the one or more attachment points.

17. The method of claim 15, wherein the attachment is releasable for enabling removal of the bracket.

18. The method of claim 17, wherein attaching the guide shaft comprises tightening a set screw to secure the attachment.

19. The method of claim 15, wherein at least one of the one or more attachment points comprises a guide hole and attaching the guide shaft comprises inserting the guide shaft through the guide hole.

20. The method of claim 14 further comprising:
cutting the horizontal leg to obtain cutouts in the horizontal leg; and
bending the baseplate to configure the baseplate in a towed out configuration.
